(19) United States
(12) Patent Application Publication
(10) Pub. No.: US 2013/0121779 A1
(43) Pub. Date: May 16, 2013

(54) METHOD AND DEVICE FOR MACHINING TOOTH EDGES

(71) Applicant: Liebherr-Verzahntechnik GmbH, Kempten (DE)

(72) Inventor: Hansjoerg Geiser, Wiggensbach (DE)

(73) Assignee: LIEBHERR-VERZAHNTECHNIK GMBH, Kempten (DE)

(21) Appl. No.: 13/666,563

(22) Filed: Nov. 1, 2012

(30) Foreign Application Priority Data
Nov. 11, 2011 (DE) 10 2011 118 312.8

(51) Int. Cl. B23F 19/12

(52) U.S. Cl. 409/8

(57) ABSTRACT

The present disclosure relates to a method for machining tooth edges of a toothed workpiece, in which a tool clamped on a tool spindle is used for machining a tooth edge of the workpiece, wherein the machining of the tooth edge is effected by a rolling movement of the tool and the workpiece, wherein advancing the tool to the tooth edge is effected via the movement of a carrier arm on which the tool spindle is arranged and which has at least two axes of rotation.

### CROSS REFERENCE TO RELATED APPLICATION

This application claims priority to German Patent Application No. 10 2011 118 312.8, entitled “Method and Device for Machining Tooth Edges,” filed Nov. 11, 2011, which is hereby incorporated by reference in its entirety for all purposes.

### TECHNICAL FIELD

The present disclosure relates to a method for machining tooth edges of a toothed workpiece, in which a tool clamped on a tool spindle is used for machining a tooth edge of the workpiece, wherein the machining of the tooth edge is effected by a rolling movement of the tool and the workpiece.

Furthermore, the present disclosure relates to a corresponding device for machining tooth edges.

### BACKGROUND AND SUMMARY

Such method and device are known from DE 103 30 474 B4. The tool for machining the tooth edge is seated on the same tool shaft as the hobbing cutter for fabricating the toothing, so that the axes of movement of the machining head of the gear cutting machine at the same time can be used for machining the tooth edges of the toothed workpiece. The arrangement of the chamfering tool on the shaft of the hobbing cutter however limits the length thereof. Furthermore, the diameter of the chamfering tool and the diameter of the hobbing cutter cannot be chosen independently of each other. In addition, the use of the chamfering tool is extremely inflexible and forces a sequential machining of the workpieces.

From DE 10 2009 019 433 A1 a device therefore is known, in which the chamfering tool is arranged on a separate machining head, which provides for a more flexible procedure. For advancing the chamfering tool to the tooth edge, two linear drives are used, so that the movement control during chamfering corresponds to the movement control usually employed for toothing gear wheels. These kinematics oriented to the production of toothings, however, lack flexibility and are expensive.

Therefore, it is the object of the present disclosure to provide a method and a device for machining tooth edges, in which the machining of the tooth edge furthermore is effected by a rolling movement of the tool and the workpiece, and the kinematics of the machining apparatus provide for a flexible machining of the tooth edges.

In accordance with the present disclosure, this object is solved in one example, by a method for machining tooth edges of a toothed workpiece, in which a tool clamped on a tool spindle is employed for machining a tooth edge of the workpiece, wherein the machining of the tooth edge is effected by a rolling movement of the tool and the workpiece. According to the present disclosure it is provided that advancing the tool to the tooth edge is effected via the movement of a carrier arm on which the tool spindle is arranged and which has at least two axes of rotation. The at least two axes of rotation of the carrier arm hence allow a considerably more flexible and simpler adjustment of the position of the tool with respect to the tooth edge of the workpiece.

In particular, the at least two axes of rotation can be used to move the tool away from a first tooth edge, after machining the same, into an engagement position with a second tooth edge of the workpiece. Advantageously, due to the superposition of the rotary movements of several axes of rotation, translatory movements of the tooth spindle are generated in a width direction of the workpiece, “w”.

The inventors of the present disclosure have recognized that the linear axis of movement adopted in the prior art from the field of gear cutting machines no longer is necessary for this movement when machining only the tooth edges and can be replaced by the considerably more flexible axes of rotation. The more flexible axes of rotation permit further applications of the carrier arm. This results in an added value of the deburring device, which would not easily be realizable with the purely linear movements.

For generating a rather uniform shape of the tooth edge, a rolling movement of the tool however still is used according to the present disclosure, in order to achieve an optimum tooth edge contour and high machining speeds.

Advantageously, the carrier arm also allows a translatory movement of the tool spindle tangentially to the workpiece. As a result, different regions of the tool can be brought in engagement with the tooth edge of the workpiece. In particular, this allows the use of different tool regions for the upper and the lower tooth edge.

Advantageously, the carrier arm has at least three axes of rotation. In particular, the translatory movement of the tool spindle tangentially to the workpiece can be generated by the movement of at least one axis of rotation, advantageously by the superposition of the rotary movements of several axes of rotation.

Particularly, the carrier arm has at least four, furthermore advantageously at least five axes of rotation. In particular, the carrier arm can have at least six axes of rotation.

In a particular embodiment, a robot arm can be used, at whose end piece the tool spindle is arranged. Such robot arm provides for a both flexible and exact positioning of the tool spindle at the tooth edge.

Furthermore, it can be provided in accordance with the present disclosure that the carrier arm allows a movement of the tool spindle with at least three translatory degrees of freedom and/or at least one rotatory degree of freedom. This allows an advancement of the tool to the tooth edge in three directions, and possibly an alignment of the tool for adaptation to helical toothings. Furthermore, beside the three translatory degrees of freedom, at least two or at least three rotatory degrees of freedom can however also be given, in order to ensure an even more flexible adjustment.

According to the present disclosure, the axis of rotation of the tool spindle furthermore can be arranged in a plane which is vertical to the last axis of rotation of the carrier arm. This arrangement provides for an optimum performance of the machining of the tooth edge by a rolling movement of the tool. Furthermore, it allows an easy inclination of the tool for machining helical toothings.

Furthermore, the method according to the present disclosure can be employed for machining a workpiece with two tooth edges, wherein the tool has a first region for machining the first tooth edge and a second region for machining the second edge of the workpiece. This allows an individual machining for example of the upper and the lower tooth edge of a gearwheel.

The first and the second region of the tool in particular can be designed for reverse directions of rotation of the tool. Alternatively or in addition, it is conceivable that the two regions produce different geometries.

Advantageously, after machining the first tooth edge by the first region, the tool can be advanced to the second tooth edge of the workpiece via the carrier arm, wherein the second tooth edge is machined by the second region with a reverse direction of rotation of the tool as compared to the first tooth edge. This provides in particular for machining both tooth edges with the same cutting direction, for example to provide for a cutting direction from the inside to the outside on both tooth edges or for a cutting direction from the outside to the inside.

By using two regions, a rotation of the tool spindle between the machining of the first and the second tooth edge thus can also be omitted.

Furthermore advantageously, in the method according to the present disclosure producing and/or machining the toothing and machining the tooth edges is effected via independently movable tools. In particular, a machining head can be used for producing or machining the toothing and a machining head independent thereof can be used for machining the tooth edges.

According to the present disclosure, producing and/or machining the toothing and machining the tooth edges can be effected at the same time in different portions of the workpiece. Alternatively, producing and/or machining the toothing and machining the tooth edges can, however, also be effected one after the other.

In a first variant of the present disclosure, machining the tooth edges can be effected on the same clamping device as the production and/or machining of the toothing of the workpiece. In particular in large workpieces with correspondingly long machining times this has certain advantages, as here clamping and changing the workpieces requires much time, so that the additional time for machining the tooth edges hardly makes a difference.

In a second alternative, machining the tooth edges can, however, be effected on a separate workpiece holder, so that between producing and/or machining the toothing and machining the tooth edges the workpiece is removed from a first workpiece holder and is clamped on a second workpiece holder. Advantageously, the machining process of the tooth edges hence is effected at separate machining stations, but likewise within a common gear cutting machine. A completely separate machining station for the tooth edges would, however, also be conceivable. In large machines, it would also be possible to use shuttle tables.

Advantageously, the first alternative, in which the two machining steps are effected on a workpiece clamped on the same workpiece holder, is used in workpieces with a diameter of more than 800 mm. Furthermore advantageously, the second alternative, in which two workpiece holders are used, on the other hand is used in workpieces with a diameter of below 800 mm, advantageously of below 500 mm.

The machining of the tooth edges according to the present disclosure advantageously comprises deburring and/or chamfering the tooth edges. Advantageously, the tooth edges therefore are machined in a chip-removing manner.

In particular for machining the tooth edges, a milling cutter can be used. When different regions of the tool are used for machining a first and a second tooth edge of the workpiece, the tool advantageously has a two-part construction.

In particular, two identically constructed milling cutters can be used, which advantageously are clamped on the tool arbor with reverse direction of rotation. In particular, via such tools cylindrical straight or helically toothed workpieces can be machined both at the bottom edge and at the upper edge.

However, there are also special applications in which the flank edge differs between the upper surface and the lower surface. In this case, two different milling cutters are necessary, which are arranged one beside the other, e.g. when machining beveloid gearwheels.

Furthermore advantageously, the tool according to the present disclosure has cutting teeth distributed around its circumference and flutes arranged in between. In particular, these cutting teeth can be arranged in multi-start form and when machining the tooth edges hence can be associated to different tooth gaps.

Due to its movability given according to the present disclosure, the carrier arm of the present disclosure can also be used for other activities apart from machining the tool edges. Particularly, the carrier arm includes an automatic change interface for accommodating different tools.

Furthermore, a magazine can be arranged in the range of movement of the carrier arm, in which at least two different tools are arranged or can be arranged. Advantageously, the carrier arm can move to the magazine and automatically change the tools.

Advantageously, the tool spindle represents such tools, which accordingly can be put down and be replaced by other tools. Alternatively, however, the tool spindle can also be constructed such that beside the actual tool it can automatically accommodate further tools.

Furthermore, a brushing device can be provided as a tool, by which re-brushing of the tooth edges is effected.

Alternatively or in addition, a tool gripper also can be provided as a tool, with which the tool of a further machining device is changed. In particular, the tool of a machining device, via which the toothing is produced and/or machined, can be changed.

Furthermore alternatively or in addition, a workpiece gripper can also be provided as a tool, with which a workpiece is loaded or unloaded. Thus, the carrier arm can also be used for loading or unloading the workpieces onto the workpiece holder of the device, and/or for loading or unloading the workpieces onto the workpiece holder of a further machining device.

The present disclosure furthermore comprises an apparatus for machining tooth edges of a toothed workpiece, with a tool spindle on which a tool can be clamped for machining a tooth edge of the workpiece and with a workpiece holder on which a workpiece can be clamped, wherein one drive each is provided for the rotatory movement of the tool spindle and the workpiece holder, and the controller of the device has a function which generates a rolling movement of the tool and the workpiece for machining the workpiece.

According to the present disclosure it is provided that the tool spindle is arranged on a carrier arm which has at least two axes of rotation. The device according to the present disclosure provides the same advantages which have already been described above with regard to the method according to the present disclosure.

In particular, the apparatus according to the present disclosure can be used for carrying out a method according to the present disclosure.

Advantageously, the carrier arm is formed such as has already been set forth above with regard to the method. Furthermore advantageously, the device as a whole also is formed such as has already been set forth above with regard to the method.

For machining the tooth edges of the workpiece, the tool spindle advantageously is movable independent of a tool holder of a further machining device which is usable for producing and/or machining the toothing of the workpiece. As has already been set forth above, the device for machining the tooth edges of the workpiece according to the present disclosure can be used completely separately from a gear cutting machine or as part of such gear cutting machine, which for producing and/or machining the toothing however includes a further machining device.

In a first alternative, the machining device is usable for producing and/or machining the toothing of a workpiece which is clamped on the workpiece holder of the device for machining tooth edges. As a result, the same workpiece holder is used both for the machining device for producing and/or machining the toothing and for the device for machining tooth edges according to the present disclosure.

Alternatively, the machining device however can include a second workpiece holder, so that a tool clamped in the tool holder is usable for producing and/or machining the toothing of a workpiece clamped on the second workpiece holder.

Furthermore advantageously, it can be provided that the carrier arm includes an automatic change interface for accommodating different tools, in particular for accommodating a brushing device and/or for accommodating a tool gripper and/or for accommodating a workpiece gripper. Advantageously, the device according to the present disclosure is equipped such as has already been set forth above with regard to the method. In particular, there can be provided a magazine for at least two tools, which is arranged in the range of movement of the carrier arm.

Furthermore, the device can comprise a tool as it has already been described above.

Furthermore advantageously, the device according to the present disclosure comprises a controller which includes functions by which a method according to the present disclosure is carried out. The corresponding functions hence implement the methods according to the present disclosure in the controller of the device according to the present disclosure. Advantageously, the controller allows an automatic performance of a method according to the present disclosure or of the different aspects of the method according to the present disclosure as set forth above.

The present disclosure furthermore comprises a gear cutting machine with a machining device for producing and/or machining the toothing of a workpiece and of a device for machining tooth edges of a toothed workpiece according to the present disclosure, as it has been set forth above. The machining device in particular can be a gear milling machine or a gear shaping machine.

As already explained above in detail, producing and/or machining the toothing of the workpiece can be effected on the same workpiece holder on which the machining of the tooth edges is effected, or on separate workpiece holders.

The present disclosure will now be explained in detail with reference to an exemplary embodiment and drawings.

### BRIEF DESCRIPTION OF THE FIGURES

FIG. 1 shows an exemplary embodiment of a device according to the present disclosure in a side view.

FIG. 2 shows the exemplary embodiment in a perspective view.

FIG. 3 shows the carrier arm of the device according to the present disclosure with the workpiece spindle according to the present disclosure.

FIG. 4 shows an enlarged view of the workpiece spindle according to the present disclosure.

FIG. 5 shows an enlarged view of a tool used according to the present disclosure with two tool regions for machining the upper and the lower tooth edge.

### DETAILED DESCRIPTION

The device according to the present disclosure and the method according to the present disclosure allow the chip-removing machining of toothed workpieces, which provides for carrying out deburring and chamfering operations along the tooth contour of a toothed workpiece edge within a relatively short machining time.

The machining device can be an independent device, but it is also imaginable to arrange this machining device on or in a gear cutting machine, in order to machine the toothed workpiece on the same clamping device on which it has been toothed, subsequent to the gear cutting operation.

This can be of interest above all in large workpieces with a toothed diameter of more than 500 mm, advantageously more than 800 mm, with correspondingly long machining times. Workpieces of this diameter frequently no longer are clamped automatically, so that the additional time for deburring and chamfering this toothing is not so important. A further clamping operation here would be distinctly longer than the actual deburring time. In addition, completely toothed and deburred workpieces thus are coming from the machine.

In smaller workpieces, however, the cycle time for machining the toothing is most important, so that the deburring process may take place at a separate deburring station. The deburring process, however, likewise can take place within the gear cutting machine.

Alternatively, however, a separate deburring station would also be conceivable for all workpiece diameters.

According to the present disclosure, a special tool is used for machining the tooth edges, in particular a tool especially adapted to the toothing to be machined.

Machining the tooth edges is effected by a rolling movement of the tool and the workpiece, which is generated by a correspondingly coupled rotary movement of the tool spindle and the workpiece holder. The shape of the chamfer at the tooth edge hence is determined substantially by the shape of the tool used.

For advancing the tool and for positioning the tool at the tooth edge, however, a carrier arm now is used according to the present disclosure, which has at least two axes of rotation.

During the machining process of the respective tooth edge, the orientation of the tool spindle relative to the workpiece however is not changed advantageously, but at best a feed movement of the tool to the workpiece is performed.

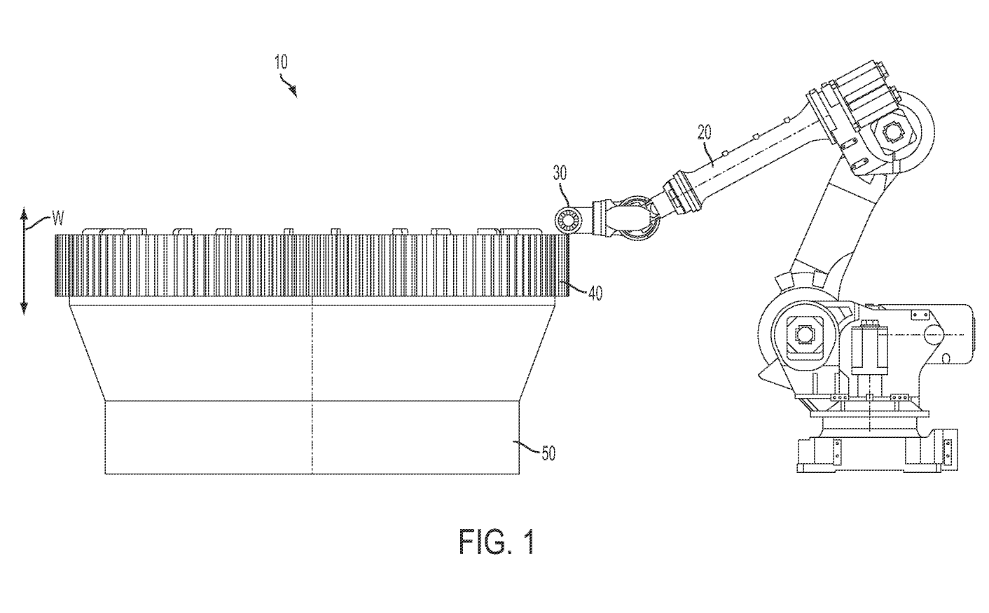

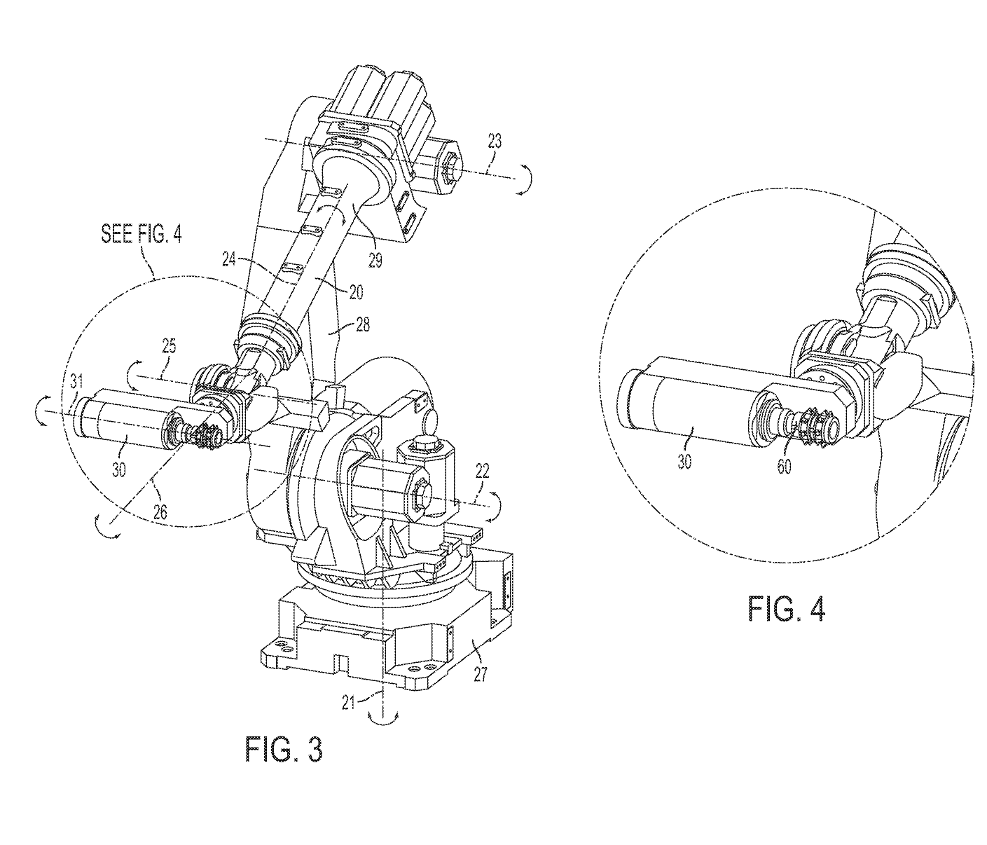

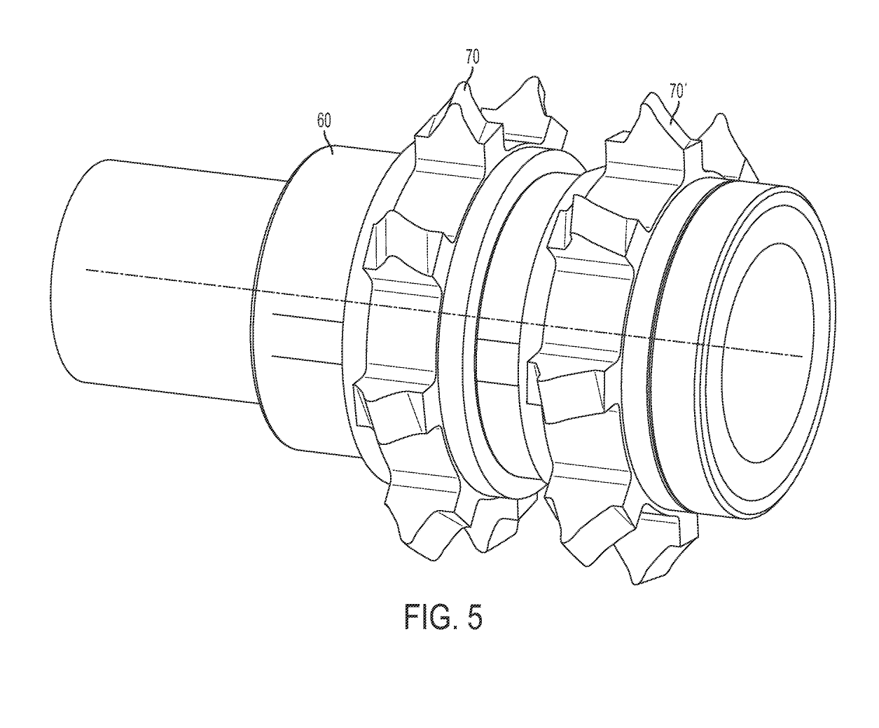

FIGS. 1 to 3 now show an exemplary embodiment of a device according to the present disclosure, in which a robot arm 20 is used, at whose end piece the motor spindle 30 is arranged for accommodating the tool. In the exemplary embodiment, the robot arm 20 has six axes of rotation 21-26, via which the tool spindle 30 can be moved with three translatory and three rotatory degrees of freedom. The last axis of rotation is identified by reference 26.

On the one hand, this allows a feed movement of the tool to the tooth edge and a movement of the tool from the upper tooth edge to the lower tooth edge and vice versa. Furthermore, the third translatory degree of freedom allows to bring different regions of the tool in engagement with the tooth edge. The rotatory degrees of freedom on the other hand allow the correct alignment of the tool relative to the tooth edge.

In the exemplary embodiment, the robot is constructed such that the entire robot arm 20 is arranged on a machine column 27 via a vertical axis of rotation 21. The axes of rotation 22 and 23 each oriented horizontally then each allow pivoting of a first arm part 28 and of a second arm part 29, respectively. A further axis of rotation 24 oriented in longitudinal direction of the second arm part 29 allows the rotation thereof. At the end of the second arm part a further axis of rotation 25 and at the same via an axis of rotation 26 in turn extending in arm direction an end piece of the robot arm is arranged.

At the end piece of the robot arm the motor spindle 30 now is arranged. The axis of rotation 31 of the motor spindle is arranged in a plane which extends vertically to the last axis of rotation 26 of the robot arm. This allows a particularly easy pivoting of the tool for example for adaptation to helical toothings.

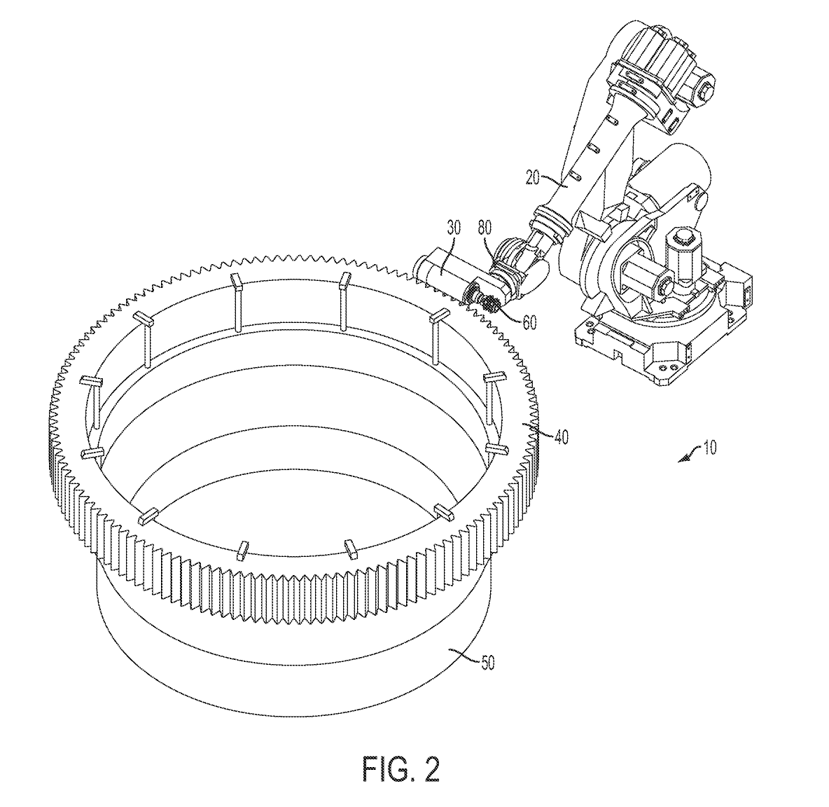

Beside the carrier arm 20, which carries the tool spindle 30, the device according to the present disclosure furthermore comprises a workpiece holder 50. In FIGS. 1 and 2, a gearwheel 40 is clamped on this workpiece holder 50. The carrier arm with the tool spindle is arranged beside the workpiece holder 50.

In the exemplary embodiment, the device according to the present disclosure is used for chamfering and deburring an externally toothed workpiece. The use in an internally toothed workpiece would, however, also be possible. For this purpose, the tool spindle 30 possibly would have to be constructed smaller or a tool 60 of a larger diameter would have to be employed. Due to the flexibility of the robot arm, however, machining of both internally and externally toothed workpieces might be effected with the same arrangement.

The device according to the present disclosure can represent a separate deburring station or, however, be integrated into a gear milling machine or a gear shaping machine.

As already set forth above, machining the tooth edges of the workpiece 40 can be effected while the same is clamped on the workpiece holder 50, on which the gear cutting operation also has been effected. In this case, machining the toothing and the tooth edges at the same time can also be effected at different points of the workpiece.

Alternatively, the workpiece can, however, also be transported from a workpiece holder, on which the gear cutting process is performed, to a second workpiece holder on which the machining of the tooth edges is effected.

The carrier arm according to the present disclosure still offers further possibilities above all when integrated into a machine. In particular, the head of the carrier arm can be provided with an automatic change interface, due to which the robot independently can perform further functions by changing the tool.

Due to a replaceable head, the tools for machining the tooth edges, in particular the deburring milling cutter, can be changed, in order to debur multiple toothings. By inserting a brushing device, the chamfer possibly might also be re-brushed.

Furthermore, by inserting a workpiece gripper, the robot might load or unload the machine with workpieces. In particular, the carrier arm can be used to load or unload the workpieces from an external transport device onto the workpiece holder of the deburring device and/or to perform the change of the workpiece from the one machining station to the other machining station in the case of two separate workpiece holders.

By using a tool gripper on the carrier arm, the robot also can carry out an automatic tool change at the machining device for producing and/or machining the toothing.

In FIG. 2, the interface for changing the machining device is provided with the reference numeral 80. In particular, the tool spindle 30 according to the present disclosure can be attached or mounted at this interface.

The device according to the present disclosure advantageously includes a controller which provides functions for the corresponding method steps. Advantageously, the controller allows an automatic performance of the method according to the present disclosure.

In FIG. 5, the example used tool, which is used in the method according to the present disclosure, now is shown in detail.

The tool includes at least one milling region 70 on which a plurality of cutting teeth are arranged spaced in circumferential direction. In particular, the individual cutting teeth can correspond to successive tooth gaps of a gearwheel and during the rolling movement get in engagement with the tooth edges of successive teeth of the gearwheel.

In the particularly advantageous aspect of the present disclosure as shown in FIG. 5, the tool includes two tool regions 70 and 70′ which each are used for machining the upper and the lower tooth edge, respectively. According to the present disclosure, the cutting edges of the two tool regions each point in opposite directions, so that with opposite directions of rotation the same can be used for machining the upper and the lower tooth edge.

In particular, there can be used two identically constructed milling cutters 70 and 70′ which are clamped onto the tool arbor 60 with reverse direction of rotation and thus form the tool according to the present disclosure. The cutting direction at the lower surface and at the upper surface of the toothing thereby is different, while the toothing geometry, however, still is the same on both sides. A corresponding tool in particular can be used in cylindrical straight or helically toothed workpieces.

However, there are also special applications in which the flank edge differs between the upper and the lower surface of the gearwheel. In this case, two deburring milling cutters with different cutting edges are necessary, for example when machining beveloid gearwheels.

In such a tool according to the present disclosure with two different regions for the upper and the lower edge, optionally one of the edges is machined first, whereupon the tool is moved away from this edge via the carrier arm and the other tool region is brought in engagement with the other edge, whereupon this edge is machined. A complete rotation of the tool spindle therefore can be omitted according to the present disclosure.

The present disclosure provides for an extremely flexible machining of the tooth edges of a gearwheel with relatively short machining times for the deburring and chamfering machining along the tooth contour of the toothed workpiece edge.

1. A method, comprising machining tooth edges of a toothed workpiece, in which a tool clamped on a tool spindle is used for machining a tooth edge of the workpiece, wherein the machining of the tooth edge is effected by a rolling movement of the tool and the workpiece, and wherein advancing the tool to the tooth edge is effected via the movement of a carrier arm on which the tool spindle is arranged and which has at least two axes of rotation.

2. The method according to claim 1, wherein the carrier arm allows a translatory movement of the tool spindle tangentially to the workpiece, wherein the carrier arm has three axes of rotation, and/or wherein the carrier arm allows a movement of the tool spindle with at least three translatory degrees of freedom and/or at least one rotatory degree of freedom.

3. The method according to claim 1, wherein an axis of rotation of the tool spindle is arranged in a plane which is vertical to a last axis of rotation of the carrier arm.

4. The method according to claim 1, wherein the workpiece has two tooth edges and the tool includes a first region for machining the first tooth edge and a second region for machining the second edge of the workpiece, wherein after machining the first tooth edge by the first region the tool is advanced to the second tooth edge of the workpiece via the carrier arm and the second tooth edge is machined by the second region with a reverse direction of rotation of the tool as compared to the first tooth edge.

5. The method according to claim 1, wherein production and/or machining of the toothing and machining of the tooth edges is effected via independently movable tools.

6. The method according to claim 1, wherein production and/or machining of the toothing and the machining of the tooth edges is effected at different portions of the workpiece at the same time.

7. The method according to claim 1, wherein production and/or machining of the toothing and the machining of the tooth edges is effected one after the other.

8. The method according to claim 1, wherein the carrier arm includes an automatic change interface for accommodating different tools, wherein a brushing means is accommodated, by which re-brushing is effected, and/or wherein a tool gripper is accommodated, with which the tool of a further machining device is changed, and/or wherein a workpiece gripper is accommodated, with which a workpiece is loaded or unloaded.

9. A device for machining tooth edges of a toothed workpiece, comprising:
a tool spindle configured to receive a tool via clamping for machining a tooth edge of the workpiece;
a workpiece holder configured to receive a workpiece via clamping;
one drive each for the rotatory movement of the tool spindle and the workpiece holder; and
a controller including non-transitory instructions and a processor for generating a rolling movement of the tool and of the workpiece for machining the workpiece, wherein the tool spindle is arranged on a carrier arm which has at least two axes of rotation.

10. The device according to claim 9, wherein for machining the tooth edges of the workpiece the tool spindle is movable independent of a tool holder of a machining device which is usable for producing and/or machining the toothing of the workpiece.

11. The device according to claim 8, wherein the machining device is usable for producing and/or machining the toothing of a workpiece which is clamped on the workpiece holder of the device for machining tooth edges, or wherein the machining device includes a second workpiece holder, so that a tool clamped in the tool holder is usable for producing and/or machining the toothing of a workpiece clamped on the second workpiece holder.

12. The device according to preceding claim 1, wherein the carrier arm includes an automatic change interface for accommodating different tool means, in particular for accommodating a brushing means and/or for accommodating a tool gripper and/or for accommodating a workpiece gripper.

13. The device according to claim 9, wherein the controller further includes instructions to:
machine tooth edges of a toothed workpiece by a rolling movement of the tool and the workpiece, including instructions to advance the tool to the tooth edge via the movement of the carrier arm.

14. The device according to claim 9, wherein the device is included in a gear cutting machine.

15. A method, comprising:
machining tooth edges of a toothed workpiece via a tool clamped on a tool spindle, the machining of a tooth edge effected by a rolling movement of the tool and the workpiece, and wherein
advancing the tool to the tooth edge via movement of a carrier arm on which the tool spindle is arranged and which has at least two axes of rotation.

16. The method according to claim 15, further comprising providing a translatory movement of the tool spindle tangentially to the workpiece via the carrier, wherein the carrier arm has three axes of rotation.

17. The method according to claim 16, wherein an axis of rotation of the tool spindle is arranged in a plane which is vertical to a last axis of rotation of the carrier arm.

18. The method according to claim 16, wherein the workpiece has two tooth edges and the tool includes a first region for machining the first tooth edge and a second region for machining the second edge of the workpiece, wherein after machining the first tooth edge by the first region the tool is advanced to the second tooth edge of the workpiece via the carrier arm and the second tooth edge is machined by the second region with a reverse direction of rotation of the tool as compared to the first tooth edge.

19. The method according to claim 15, wherein the carrier arm includes an automatic change interface for accommodating different tools.
